(19) United States
(12) Patent Application Publication
(10) Pub. No.: US 2007/0155269 A1
(43) Pub. Date: Jul. 5, 2007

(54) Fiber bonding treatment for press fabrics and method of applying a bonding resin to a press fabric

(76) Inventors: Sanjay Patel, Charleston, SC (US); Robert Crook, Wilson, NC (US); Bryan Wilson, Raleight, NC (US)

Correspondence Address: HERSHKOVITZ & ASSOCIATES, 2845 DUKE STREET, ALEXANDRIA, VA, 22314, US

(21) Appl. No.: 11/509,012

(22) Filed: Aug. 24, 2006

Related U.S. Application Data
(60) Provisional application No. 60/711,586, filed on Aug. 26, 2005.

(51) Int. Cl. B32B 27/04; B32B 5/02

(52) U.S. Cl. 442/149; 442/268; 442/286; 156/296

(57) ABSTRACT

A press felt for the press section of a papermaking machine can include a base fabric and at least one layer of an assembly of fibers, can form a carded web or batt, the assembly of fibers containing a plurality of fibers. The press felts can be produced with reduced fine diameter surface cap loss without having to “contaminate” the surface of a fabric with a high percentage of bonding resin, while preserving a high degree of permeability in the overall structure. Other aspects of the disclosure are directed to a method for applying a bonding resin to a press felt.

### CROSS-REFERENCE TO RELATED APPLICATIONS

The present application claims priority to U.S. provisional application 60/711,586, filed on Aug. 26, 2005, the disclosure of which is expressly incorporated by reference herein in its entirety.

### BACKGROUND OF THE INVENTION

1. Field of the Invention

This disclosure relates to fabrics utilized in papermaking processes and, more specifically, in the press section of papermaking machinery. More particularly, this disclosure relates to press felts (or fabrics) which can reduce fine diameter surface cap loss without having to “contaminate” the surface of a fabric with a high percentage of bonding resin, while preserving a high degree of permeability in the overall structure.

2. Discussion of Background Information

Papermaking processes can include the steps of forming the paper fibers into a matted sheet, dewatering the sheet, pressing the matted sheet through rollers to continue the dewatering process and to give the consolidated sheet its desired texture, and further drying the sheet as necessary to remove any remaining excess water from the sheet. Consequently, a papermaking machine generally can include three pertinent sections: the forming section, the press section and the dryer section.

The procedure of papermaking can begin in the forming section with preparation of a pulp slurry. The pulp slurry can be carried through the forming section of the papermaking machine on a forming fabric, not unlike a porous conveyor belt, where the pulp slurry can be formed into a sheet. In the forming section, the sheet can be formed and transported to the press section of the papermaking machine where the process of removing the water from the sheet, begun in the forming section, can be continued.

In the press section of a papermaking machine, the wet, matted sheet of paper fibers can be transported on one or more press fabrics and can be passed through rollers along with the press fabrics such that, in a press nip, at least some of the remaining water can be squeezed out of the sheet and can be absorbed through the permeable press fabric. As compression is increased between the rollers, water removal can be likewise increased. The function of pressing also can consolidate the sheet and provide texture to the surface of the sheet.

Some possible beneficial press felt or fabric properties can include resistance to abrasion, resistance to compaction, heat and chemical resistance as well as strength, permeability and caliper retention.

Within the press section, the sheet can be supported and transported via one or more fabrics referred to as “press felts” (or “press fabrics”). For purposes of this disclosure, the term “press felts” (or “press fabrics”) as used herein shall refer to those fabrics that can be used in the press section of a papermaking machine to support and transport the formed sheet of paper fibers to the dryer section of the machine where even more water can be removed.

Press felts can, for example, include a base fabric (for example a woven or non-woven cloth) that can have a staple fiber batt that can be needle punched thereto. In many press felts, multiple layers of batt fibers can be needle punched to the paper side of the base cloth.

The base fabric of press felts can, for example, be made of 100 percent synthetics, primarily nylon polymers, although polyester and other materials can also be utilized.

It will be appreciated that the term “base fabric,” as used herein, refers to the underlying substrate of the press felt and can include scrim and composite structures as well as those woven and non-woven fabrics known in the art as being suitable for use in press felts for papermaking machinery. Base fabrics can be, for example, woven or otherwise constructed with cabled monofilaments, plied multifilaments, spun yarns or single monofilaments. Base fabrics can be utilized in a single layer or multilayer mesh, and can be woven as endless belts or woven flat and joined with seams. The weave of the base fabric can be constructed to affect pressure uniformity, flow resistance, void volume and compression properties. These base fabrics can be classified as conventional (endless) designs, stratified (laminated) designs, and seam fabrics. The monofilaments or fibers used therein can be, for example, round in cross-section, flat monofilaments, and hollow monofilaments as the fibers used in the base fabric. Alternatively, the base fabric can be, for example, a scrim, an extruded netting, or a composite structure, for example an extruded spun-bonded sheet.

The batt can be made from any suitable material, such as, and for example, from nylon fibers or other similar synthetic materials, which fibers can be, for example, round in cross section.

It will be appreciated that, for the purposes of this disclosure, the term “batt” refers to essentially any kind of assembly or web of fibers other than the base fabric which can be suitable for use in press felts, and is not necessarily limited to conventional batting. The fibers can be carded into a uniform web to form the batt before being needle punched onto the base fabric, for example in a series of layers. Moreover, the batt fibers can be needle punched into the base fabric with the fibers oriented in the cross machine direction or in the machine direction, although alternative methods for needle punching now exist. The needling process can be engineered to affect the density, surface properties and permeability of the press fabric.

Permeable fabrics such as press felts can be prone to surface wear. This can especially be true when the batt structure of the fabric can be stratified and a finer dtex fiber can be utilized on the surface of the fabric to form a fine “cap” layer, with coarser layers of fiber underneath. It can be difficult to needlepunch this fine “cap” layer into the coarse underlay effectively, to be both strong and wear resistant, as well as keeping the fine fiber on the surface in a homogenous layer to provide sheet support, enhance dewatering, make the sheet smoother, etc. Finer dtex fibers can be inherently weak. Resin treatments and low melt binding of fibers can be utilized to reinforce these weak fine diameter surface fibers. However, the presence of these elements can change the openness, porosity, density and flow properties of the surface of the fabric, which can result in negative effects on performance.

U.S. Pat. No. 4,151,323 to Christie, the subject matter of which is incorporated herein in its entirety, discloses multilayered belts for use in a papermaking machine that comprise a fibrous base layer, the fibers of which are resin encapsulated, and a substantially resin-free fibrous surface layer in which the portions of the fibers that contact the fibers of the base layer are also substantially entirely encapsulated with resin.

U.S. Pat. No. 4,500,588 to Lundstrom, the subject matter of which is incorporated herein in its entirety, discloses a conveyor felt for paper making and a method of manufacturing such a felt. Lundstrom further discloses a fine-fibered layer, on the side of a conveyor felt, that faces a conveyed fiber web, and an underlying coarse-fibered layer.

### SUMMARY OF THE INVENTION

Aspects of one or more embodiments described in this disclosure can provide a press felt with reduced fine diameter surface cap loss without having to “contaminate” the surface of a fabric with a high percentage of bonding resin, and can preserve a high degree of permeability in the overall structure.

At least one aspect of this disclosure can be attained by a method of applying a bonding resin to a fabric including a batt portion and a cap or surface layer, including: applying a bonding resin to a roll side surface of a fabric; and activating the bonding resin to form a polymer; wherein the polymer bonds fibers in a predetermined area of the batt portion and wherein the polymer penetrates the cap layer in an amount of less than approximately 70% of void volume that was available in the cap layer prior to application of the bonding resin.

At least one other aspect of this disclosure can be attained by a method of applying a bonding resin selected from elastomer resin, polyurethane resin, amorphous polymer resin, polyhydroxyether resin, reactive particulate adhesive resin, polystyreneacrylate copolymer resin, epoxidized styreneacrylic copolymer resin, laminating adhesive resin, copolyamide resin, copolyester resin, or combinations of these resins.

At least one other aspect of this disclosure can be attained by a method of applying a bonding resin where the diameter of solids in the bonding resin range from approximately 10 μm to approximately 100 μm, or for example where the diameter of solids in the bonding resin range from approximately 20 μm to approximately 30 μm.

At least one other aspect of this disclosure can be attained by a method of applying a bonding resin where measured air flow as CFM drop can be less than 50%, or for example from approximately 10% to approximately 20%.

At least one other aspect of this disclosure can be attained by a method of applying a bonding resin where penetration of the polymer into the cap layer occurs in an amount of less than approximately 70%, or for example from approximately 3% to approximately 50%, of the void space in the cap layer.

At least one other aspect of this disclosure can be attained by a method of applying a bonding resin where the cap layer is less than approximately 17 dtex, for example less than approximately 3.5 dtex.

At least one other aspect of this disclosure can be attained by a method of applying a bonding resin where the resin is a mix of particle sizes such that a component of large particles are trapped in coarser roll side bat, resulting in high fiber bonding and wear resistance.

At least one other aspect of this disclosure can be attained by a method of applying a bonding resin where the resin is applied only to a localized area including at least one of a join area in the base fabric and a seam on an on-machine seamed felt.

At least another aspect of this disclosure can be attained by a papermaking fabric having a roll side surface and paper side surface, the fabric including: a batt portion; a cap layer; and a polymer formed from a bonding resin; where the papermaking fabric is formed by applying the bonding resin to the roll side surface, and when the resin is activated, the bonding resin forms the polymer that bonds fibers in a predetermined area of the batt portion and wherein the polymer does not fill the cap layer.

At least one other aspect of this disclosure can be attained by a papermaking fabric where the resin is at least one resin selected from elastomer resin, polyurethane resin, amorphous polymer resin, polyhydroxyether resin, reactive particulate adhesive resin, polystyreneacrylate copolymer resin, epoxidized styreneacrylic copolymer resin, laminating adhesive resin, copolyamide resin, copolyester resin, and combinations of these resins.

At least one other aspect of this disclosure can be attained by a papermaking fabric where an average diameter of solids in the bonding resin range from approximately 10 μm to approximately 100 μm, or for example where the average diameter of solids in the bonding resin range from approximately 20 μm to approximately 30 μm.

At least one other aspect of this disclosure can be attained by a papermaking fabric where measured air flow as CFM drop is less than approximately 50%, or for example from approximately 10% to approximately 20%.

At least one other aspect of this disclosure can be attained by a papermaking fabric where an amount of the polymer that penetrates into the cap or surface layer is an amount less than approximately 70%, or for example an amount of from approximately 3% to approximately 50% of void space available in the cap or surface layer prior to application of the bonding resin.

At least one other aspect of this disclosure can be attained by a papermaking fabric where the surface or cap layer is less than approximately 17 dtex, for example less than approximately 3.5 dtex.

At least one other aspect of this disclosure can be attained by a papermaking fabric where the resin comprises a mix of particle sizes such that a component of large particles are trapped in coarser roll side batt, resulting in high fiber bonding and wear resistance.

At least one other aspect of this disclosure can be attained by a papermaking fabric where the resin is applied only to a localized area comprising at least one of a join area in the base fabric and a seam on an on-machine seamed felt.

At least another aspect of this disclosure can be attained by a press felt, including: a fabric comprising a roll side surface and paper side surface; a batt portion; a cap layer, of from approximately 1.7 dtex to approximately 3.3 dtex, that forms the paper side surface; and a polymer formed from a bonding resin that contained solids in a range from approximately 10 μm to approximately 100 μm, or for example where the average diameter of solids in the bonding resin range from approximately 20 μm to approximately 30 μm, immediately prior to activation; where the polymer bonds fibers only in at least one of a join area and a seam area in a base fabric area of the batt portion but the bonding resin penetrates the cap layer in an amount of less than approximately 70% or an amount ranging from approximately 0% to approximately 50% of void space available in the cap layer prior to application of the bonding resin.

At least one other aspect of this disclosure can be attained by a press felt formed by any of the methods described above and/or herein.

At least one other aspect of this disclosure can be attained by a papermaking machine including a press felt and/or papermaking fabric as described above and/or herein.

These together with other aspects that will be subsequently apparent, reside in the details of construction and operation as more fully hereinafter described and claimed.

Other exemplary embodiments and advantages of this disclosure can be ascertained by reviewing this disclosure and the accompanying drawings.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1 is directed to a cross-sectional view of a papermaking felt in accordance with this disclosure; and

FIG. 2 is directed to a papermaking felt as part of a papermaking machine, in accordance with this disclosure.

### DETAILED DESCRIPTION OF THE PRESENT INVENTION

The particulars shown herein are by way of example and for purposes of illustrative discussion of the aspects of this disclosure only and are presented in the cause of providing what is believed to be the most useful and readily understood description of the principles and conceptual aspects of this disclosure. In this regard, no attempt is made to show structural details of this disclosure in more detail than is necessary for the fundamental understanding of this disclosure, the description taken with the drawings making apparent to those skilled in the art how the several forms of this disclosure may be embodied in practice.

In general, a press felt (or fabric) suitable for use in transporting a sheet of paper fibers through the press section of a papermaking machine can include a base fabric and at least one layer of an assembly of fibers securely attached to the base fabric. In accordance with this disclosure as set forth hereinbelow, the assembly of fibers, i.e., batt, includes a plurality of fibers.

Further aspects of the invention can include a method for making the press felt.

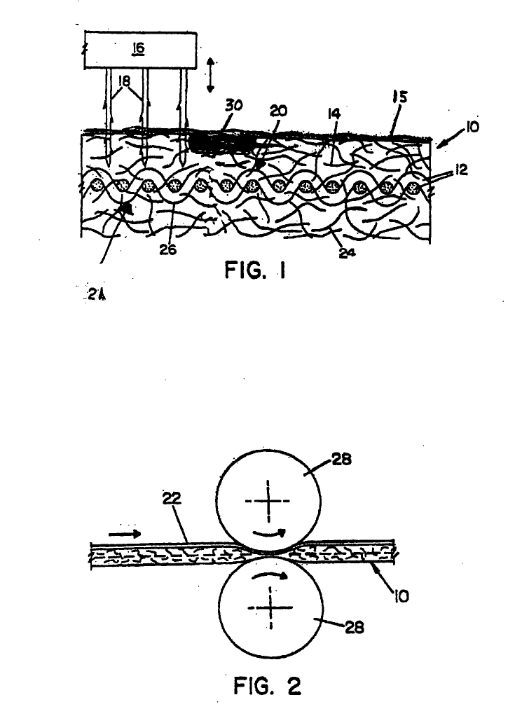

A cross-sectional view of an exemplary press felt or fabric that can be utilized for transporting a sheet of paper fibers through the press section of a papermaking machine is represented generally by reference numeral 10 in FIG. 1.

The press felt (or fabric) 10 can take various forms of press felts, such as, and for example, batt-on-base felts, baseless felts, batt-on-mesh felts, felts with no-crimp base fabric, composite fabrics, and laminated (stratified) press felts.

The press fabric 10 can, for example, include a base fabric 12 and one or more layers of an assembly of fibers, such as batt 14, securely attached to the base fabric 12, for example by needle punching utilizing a needle punching apparatus 16. A surface (or “cap”) layer 15 of fine fibers, such as the fine-fibered layer of U.S. Pat. No. 4,500,588 to Lundstrom, which is incorporated herein by reference, can also be securely attached to the base fabric 12 and the batt 14, for example utilizing needle punching.

An underlying coarse-fibered layer, not shown, such as that of U.S. Pat. No. 4,500,588 to Lundstrom, can optionally be included in the press fabric 10.

The apparatus 16 is shown with needles 18 for punching the assembly of surface layer 15 and the fibers 14 into the base fabric 12. Where only one layer of fibers 14 is employed, it can be needle punched into the side 20 of the base fabric 12 facing the sheet of paper fiber 22, i.e., the paper side of the base fabric, and can therefore be disposed generally between the base fabric 12 and the surface layer 15. As shown in FIG. 2, a sheet of paper fibers 22 lies adjacent to the surface layer 15 of the press fabric 10.

A second layer 24 of batt fibers can optionally be employed. Such layer 24 can be needle punched into the other side 26 of the base fabric facing or contacting the roller(s) 28 of the papermaking machine, i.e., the machine side (also referred to herein as the “roll side”) 21 of the base fabric, or can be needle punched through the paper side of the base fabric to the machine side. Various methods of application (e.g., needle punching) of the assembly of fibers 14 to the base fabric 12 can be utilized to sufficiently and securely attach the assembly of fibers 14 to the base fabric 12. For example, multiple layers of fibers 14 can be needle punched into the base fabric 12.

The base fabric 12 can, for example, be woven (except for no-crimp base fabrics) or formed as a composite and can be made from any of a number of methods. For example, the fabric can be a single layer or multilayer mesh, and can be woven as an endless belt or woven flat and joined later. The base fabric 12 can be woven in a number of alternative manners to manipulate and otherwise provide particular characteristics and properties to the base fabric. For example, the fabric can be stratified or laminated with additional fabrics on its surface to create additional layers, or one or more layers of fabric can be employed.

The base fabric 12 can be constructed from any suitable material. For example, the base fabric 12 can be made of 100 percent synthetics, although wool can alternatively be employed. Polyamide (nylon) polymers can be utilized, but the base fabric 12 can also be constructed of polyester, polyphenylene sulfide, or other similar materials. Nylon can have greater resistance to compaction in the press nip compared to polyester, and can be more abrasion resistant, tougher, and can needle with less breakage compared to polyester.

The base fabric 12 can be constructed in any suitable manner. For example, the base fabric 12 can be formed of cabled monofilaments, plied multifilaments, spun yarns, and/or single monofilaments. Each type of fiber can have properties that influence operational characteristics of the press felt 10 and can be chosen based upon the particular characteristic desired of the base fabric 12. For example, multifilaments can be more durable and have higher elongation than monofilaments, but can be more compressible and less resistant to chemical attack.

It will be appreciated that the term “batt” as used herein refers not only to a soft, bulky bundle of fibers forming a layer on the surface of the base fabric 12, but also to any other type of assembly of fibers, be it woven or nonwoven, carded or not carded, suitable for use in the press section of a papermaking machine.

The batt fibers 14 of the press felt 10 can contain a plurality of fibers, each of which can be cut to any suitable length, for example a length of from about 1 inch to about 6 inches, and for example, from about 3.0 inches to about 4.0 inches. The fibers forming the batt 14 can be any suitable denier, for example a denier in a range from about 3 denier to about 50 denier, or from about 15 denier to about 25 denier.

The fibers that form the batt 14 can be, for example, non-woven and made from 100 percent synthetics, for example, nylon, polyester or polyphenylene sulfide. For example, the fibers can be made from a nylon selected from the group consisting of nylon 6, nylon 6,6, nylon 6,10, nylon 6,12, nylon 11, nylon 12, copolymers thereof, and blends thereof.

The fibers can be, for example, coated with a hydrophilic (or alternatively a hydrophobic) finish. The hydrophilic (or hydrophobic) finish may be permanent or non permanent.

The hydrophilic (or hydrophobic) finish can be applied to the fibers during any of a number of different steps of the production process. For example, the finish can be applied in the draw bath given the fibers. For example, the fibers can be first quenched with air and then drawn and textured. As another alternative, the finish can be applied in a stufferbox during a crimping process. The finish can be sprayed onto the fibers at a stufferbox and then sent to an oven where the finish can be cured with steam or hot air. In another alternative, the non-permanent finish can be applied directly to the fibers after they come out of an oven.

Once formed, the fibers can be cut to any suitable length, for example to a length of from about 1 inch to about 6 inches. The fibers can be cut to a single length or at multi-lengths, and can be cut variably (i.e., cut to a different length with each cut) or in unison (i.e., cut a single length first, then a second length, and so on).

The assembly of fibers or batt 14 can be produced by any suitable method. For example, processing can include blending the fibers together and then carding them into a uniform web. The web of fibers may or may not be preneedled together before being applied in a series of layers onto the base fabric 12 to form the batt 14.

The web of fibers forming the batt 14 and the base fabric 12 can then be fed through a zone where several thousand barbed needles, such as 18, can be needle punched into the composite to tack the web or assembly of fibers (i.e., batt) to the base fabric. The assembly of fibers can be spliced at the start and stop of web application in the cross machine direction. Some embodiments can apply the web in a spiral method that eliminates cross machine direction oriented splices.

Once the batt fibers 14 have been needle punched onto the base fabric 12, a press felt 10 according to the concepts of the present invention is formed. The press felt 10 can then be disposed within the press section of a papermaking machine and utilized to dewater sheets of paper fibers.

The fibers of this disclosure can be suitable for utilization as batt in press felts, but are not necessarily limited thereto. For example, the fibers can alternatively be suitable for use in baseless, non-woven press felts. The press felts can be manufactured with equipment and methods other than what is detailed hereinabove, it being understood that the equipment and methods for producing the press felts, base fabrics and batt, as well as other materials, have been described for purposes of illustration and demonstration only. That is, the description and illustration is shown hereinabove is byway of example, and the scope of the claims below is not limited to the exact details shown or described.

Aspects of this disclosure can utilize a felt as a filter by applying a suitable bonding resin, for example bonding resin 30 shown in FIG. 1, that can bond fibers to each other in a predetermined area of the batt 14. The resin 30 can be applied from the open roll side 21 of the fabric. The resin 30 can be applied in a manner such that the resin 30 does not (or alternatively does not substantially) penetrate through the fine/dense surface layer 15 to the surface, and the resin 30 does not fill up the void spaces of the base fabric 12.

Initially, a press felt 10 can be needle punched with desired fine dtex surface fiber layer 15 to create a greater density and finer pore distribution on this sheet side surface versus the rest of the fabric structure. From the roll side 21 of the fabric, that has a significantly greater open pore structure due to the base fabric 12, coarse underlay batt, etc., a suspension of water and binding resin solids can be applied.

The binding resin solids can be in the form of a suspended powder, the powder selected to have a particular range of particulate diameters, such that this average diameter can be unable to penetrate through the available pore spacing of the dense sheet side surface layer. Accordingly, the majority of the binding resin solids can settle in to the predetermined interface area between the surface layer 15 and the next sublayer of batt. The resin 30 can then be “activated” as required, for example, via thermal activation, and evaporation of solvent, and the like, to effectively bond the fine dtex surface layer 15 fibers to the substrate. The adhesive can be a fiber to fiber adhesive, specifically not in the form of a continuous “film” or as a viscous resin that encapsulates all that it touches, such that the roll inside yarns and coarse underlay fiber layers are not “filled”, and permeability is not reduced significantly.

The bonding resin 30 can be any suitable material. For example, the bonding resin can be an elastomer, for example ESTANE® 58810 polyurethane, in order to provide resilience to the structure. The bonding resin, for example, can be mixed with a highly tenacious thermoset adhesive, for example, VINNEX® having cross-linking bonding particles, to provide to the fabric increased compaction resistance and relative stiffness.

Superior bonding can allow the utilization fine dtex fibers, for example less than about 2.5 dtex, and of unusually fine dtex surface fibers, such as about 1.7 dtex, to produce a smoother and dryer sheet. The added resin can also help improve pressure uniformity to the sheet. The preferential resin that can be applied can also have some effect on reducing re-wet by creating a finer pore structure in the cap/sublayer interface zone of the batt structure. The resin can be selected to be hydrophobic, or hydrophilic, to enhance this effect in correspondence with the desired paper grades.

In another aspect of this disclosure, other embodiments can have a mix of particle sizes selected, so that there can be, by intention, a small component of large particles that can be trapped in the coarser role side batt, resulting in enhancement of the fiber bonding and wear resistance with minimal decrease in permeability.

The amount of felt fabric having this treatment can range from a localized area that needs extra reinforcement, for example, at a join area in a base fabric, or the seam on an on-machine seamed felt, to the entire fabric.

### Exemplary Embodiment

A needle punched press fabric, composed of a solid mono woven double a layer base, that can be made endless or for on-machine seaming, an ultra-coarse fiber nonwoven base component of at least 67 dtex is own laminated to the woven base, and a sublayer of cross-laid batt of 22 dtex and a fine 3.3 dtex cap layer is needled in to make the sheet side of the fabric. Approximately 100 gsm of resin bonding solids, with an average diameter in the range of approximately 20-30 μm, is applied to this felt fabric from the roll side so that a majority of these solids penetrates to the interface of the 3.3 and 22 dtex layers, with virtually none, or in some cases only a small percentage in discontinuous “cells”, penetrating completely to the surface, and also a minority of the solids that would remain trapped in the large pore structure of the coarse batt layers and base structure. When activated, the resin significantly enhances fiber bonding and allows the felt to perform at a high level for an extended period of time. In the case of a seam felt, the felt, can perform without causing a sheet mark from the seam for an extended period of time.

It is noted that the resin bonding particles can be applied from the roll side of the fabric.

The resin can be selected from any suitable material such as and for examples: elastomers, for example polyurethane; amorphous polymers, for example polyhydroxyether; reactive particulate adhesives, for example polystyreneacrylate copolymers, epoxidized styreneacrylic copolymers; laminating adhesives, for example copolyamides, copolyesters; and combinations of these resins.

The particle size of the resin can be any suitable size. For example, the particle size can be P, where P can range up to about 500 microns. As another example, P can be in a range of approximately 0<P<500 microns. As another example, P can be in a range of approximately 0<P<50 microns. As another example, P can be about 50 microns.

Selection of the substrate and the dispersion is such that the CFM drop can, for example, by less than 50%. In other words, the measured air flow as CFM in the product can, for example, have a drop of less than 50%, for example between from about 10% to about 20%.

Penetration of the resin into the cap layer can occur, but can remain at a suitable percentage, for example at an amount less than about 70% of the void volume that was available in the cap layer prior to the application of the bonding resin, and for example from about 3% to about 50% of the void volume that was available in the cap layer prior to the application of the bonding resin.

It is noted that the foregoing examples have been provided merely for the purpose of explanation and are in no way to be construed as limiting of this disclosure. While this disclosure has been described with reference to exemplary embodiments, it is understood that the words which have been used herein are words of description and illustration, rather than words of limitation. Changes may be made, within the purview of the appended claims, as presently stated and as amended, without departing from the scope and spirit of this disclosure in its aspects. Although this disclosure has been described herein with reference to particular means, materials and embodiments, this disclosure is not intended to be limited to the particulars disclosed herein; rather, this disclosure extends to all functionally equivalent structures, methods and uses, such as are within the scope of the appended claims.

What is claimed is:

1. A papermaking fabric having a roll side surface and paper side surface, the fabric comprising:
a batt portion;
a surface layer that forms the paper side surface; and
a bonding resin;
wherein the papermaking fabric is formed by applying the bonding resin to the roll side surface, and when the resin is activated, the bonding resin bonds fibers in a predetermined area of the batt portion and wherein the bonding resin does not fill the surface layer.

2. The papermaking fabric of claim 1, wherein the resin comprises at least one of, elastomer resin, polyurethane resin, amorphous polymer resin, polyhydroxyether resin, reactive particulate adhesive resin, polystyreneacrylate copolymer resin, epoxidized styreneacrylic copolymer resin, laminating adhesive resin, copolyamide resin, and copolyester resin.

3. The papermaking fabric of claim 1, wherein a diameter of solids in the bonding resin range from one of, 10 μm to 100 μm and 20 μm to 30 μm.

4. The papermaking fabric of claim 1, wherein measured air flow as CFM drop is one of, less than 50%, and approximately from 10% to 20%.

5. The papermaking fabric of claim 1, wherein an amount of the polymer that penetrates into the surface layer is one of, less than 70% and approximately from 3% to 50% of void space available in the surface layer prior to application of the bonding resin.

6. The papermaking fabric of claim 1, wherein the surface layer is one of, less than 17 dtex and less than 3.5 dtex.

7. The papermaking fabric of claim 1, wherein the resin comprises a mix of particle sizes such that a component of large particles are trapped in coarser roll side batt.

8. The papermaking fabric of claim 1, wherein the resin is applied only to a predetermined area comprising at least one of a join area in the base fabric and a seam on an on-machine seamed felt.

9. A papermaking machine comprising the papermaking fabric of claim 1.

10. A press felt, comprising:
a fabric comprising a roll side surface and paper side surface;
a batt portion;
a surface layer, of from 1.7 dtex to 3.3 dtex, that forms the paper side surface; and
a polymer formed from a bonding resin that contains solids in a range from 10 μm to 100 μm immediately prior to activation;
wherein the polymer bonds fibers only in at least one of a join area and a seam area in a base fabric area of the batt portion but the bonding resin penetrates the surface layer in an amount ranging from 0% to 50% of void space available in the surface layer prior to application of the bonding resin.

11. A papermaking machine comprising the press felt of claim 10.

12. A method of applying a bonding resin to a fabric including a batt portion and a surface layer, comprising:
applying a bonding resin to a roll side surface of a fabric; and
activating the bonding resin;
wherein the resin bonds fibers in a predetermined area of the batt portion and wherein the resin penetrates the surface layer to a degree of penetration that fills less than 100% of void volume that was available in the surface layer prior to application of the bonding resin.

13. The method of claim 12, wherein the resin is at least one of an elastomer resin, a polyurethane resin, an amorphous polymer resin, a polyhydroxyether resin, a reactive particulate adhesive resin, a polystyreneacrylate copolymer resin, an epoxidized styreneacrylic copolymer resin, a laminating adhesive resin, a copolyamide resin, and a copolyester resin.

14. The method of claim 12, wherein the average diameter of solids in the bonding resin range from one of, approximately 10 μm to 100 μm and approximately 20 μm to 30 μm.

15. The method of claim 12, wherein measured air flow as CFM drop is one of, less than approximately 50%, and approximately 10% to 20%.

16. The method of claim 12, wherein the degree of penetration is one of, less than approximately 70% and from 3% to 50% of void space available in the surface layer prior to application of the bonding resin.

17. The method of claim 12, wherein the surface layer is less than 3.5 dtex.

18. The method of claim 12, wherein the resin comprises a mix of particle sizes such that a component of large particles are trapped in coarser roll side batt.

19. The method of claim 12, wherein the resin is applied only to a predetermined area comprising at least one of a join area in the base fabric and a seam on an on-machine seamed felt.

20. The method of claim 12, wherein the resin comprises a hydrophobic material that provides reduced rewet behavior than would occur in the absence of the hydrophobic material.

21. The method of claim 12, wherein the resin improves at least one of resistance to abrasion, resistance to compaction, heat resistance, chemical resistance, strength, permeability, and caliper retention.

22. A press felt formed by the method of claim 12.
